(19) United States
(12) Patent Application Publication
(10) Pub. No.: US 2019/0094630 A1
(43) Pub. Date: Mar. 28, 2019

(54) PIXEL STRUCTURE AND LIQUID CRYSTAL DISPLAY PANEL

(71) Applicant: Wuhan China Star Optoelectronics Technology Co., Ltd., Wuhan City (CN)

(72) Inventor: Kaixiang Zhao, Wuhan City (CN)

(21) Appl. No.: 15/506,249

(22) PCT Filed: Feb. 16, 2017
(86) PCT No.: PCT/CN2017/073712

§ 371 Date: Feb. 24, 2017

(30) Foreign Application Priority Data
Jan. 23, 2017 (CN) 201710050723.6

(51) Int. Cl. G02F 1/1343

(52) U.S. Cl. CPC G02F 1/134309; G02F 2201/52; G02F 2001/134345

(57) ABSTRACT

The present invention provides a pixel structure and a liquid crystal display panel. Based on the theory of color, the pixel structure includes, in each of pixel units, a first sub-pixel (P1), a second sub-pixel (P2), a third sub-pixel (P3), a the fourth sub-pixel (P4) arranged sequentially in a line. The first sub-pixel (P1) and the fourth sub-pixel (P4) are respectively arranged at two sides of the second sub-pixel (P2) and the third sub-pixel (P3). The second sub-pixel (P2) and the third sub-pixel (P3) have areas that are identical. The first sub-pixel (P1) and the fourth sub-pixel (P4) have color resists having the same color. The first sub-pixel (P1) and the fourth sub-pixel (P4) have areas that are one half of the area of the second sub-pixel (P2). By setting the color of the first sub-pixel (P1) and the fourth sub-pixel (P4) as a color that is opposite to the color toward which color shift may happen, color correction can be achieved and color shifts at different viewing angle may be compensated to thus improve color shift at large viewing angles.

### BACKGROUND OF THE INVENTION

### 1. Field of the Invention

The present invention relates to the field of display technology, and more particular to a pixel structure and a liquid crystal display panel.

### 2. The Related Arts

Liquid crystal display (LCD) has various advantages, such as thin device body, low power consumption, and a wide range of applications, and has been widely used, such as liquid crystal televisions, mobile phones, personal digital assistants (PDAs), digital cameras, computer screens, and notebook computer screens, and takes a leading position in the field of flat panel displays.

Most of the liquid crystal display devices that are currently available in the market are backlighting LCDs, which comprise an enclosure, a liquid crystal panel arranged in the enclosure, and a backlight module arranged in the enclosure. A liquid crystal display panel is generally made up of a color filter (CF) substrate, a thin film transistor (TFT) array substrate, and a liquid crystal layer interposed between the two substrates. A pixel electrode and a common electrode are respectively provided on inner sides of the two substrates so that through application of a voltage to control liquid crystal molecules to change direction, light emitting from the backlight module can be refracted out to generate an image.

A liquid crystal display panel comprises a plurality of pixel units. As shown in FIG. 1, a conventional pixel unit P′ comprises a red sub-pixel R′, a green sub-pixel G′, and a blue sub-pixel B′, which are arranged side by side in sequence, and the sub-pixels of the three colors have the same surface area and are consistent in size. Heretofore, due to factors including opto-electric property of the liquid crystal itself (such as a relatively large difference of birefringence of liquid crystal molecules) and a material used in combination thereof, when the direction in which eyes view the liquid crystal display panel is not a front view and the viewing angle is lager, a color that is actually viewed is shifted away from a color that is displayed. Color shift at a large viewing angle may readily cause color difference and this would causes influence on users' experience and also causes influence on product quality on manufacturer side.

Reducing color shift is a trend for the development of the liquid crystal display panels. However, the technology that is available heretofore makes it hard to fix the issue of large viewing angle color shift during a manufacturing process.

### SUMMARY OF THE INVENTION

An objective of the present invention is to provide a pixel structure, which helps compensate color shifts at different viewing angles and improve the color shift issue at large viewing angle.

Another objective of the present invention is to provide a liquid crystal display panel that has reduced color shift at a large viewing angle and provides better quality of displaying.

To achieve the above objectives, the present invention provides a pixel structure, which comprises a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel.

Optionally, the color of the color resists of the first sub-pixel and the fourth sub-pixel is blue, the color of color resist of the second sub-pixel is red, the color of color resist of the third sub-pixel is green.

Optionally, the color of the color resists of the first sub-pixel and the fourth sub-pixel is red, the color of color resist of the second sub-pixel is green, the color of color resist of the third sub-pixel is blue.

Optionally, the color of the color resists of the first sub-pixel and the fourth sub-pixel is green, the color of color resist of the second sub-pixel is red, the color of color resist of the third sub-pixel is blue.

Each of the pixel units further comprises a fifth sub-pixel, the fifth sub-pixel being arranged at one side of the first sub-pixel that is distant from the second sub-pixel or one side of the fourth sub-pixel that is distant from the third sub-pixel; and the fifth sub-pixel has color resist having a color of blank.

The present invention also provides a liquid crystal display panel, which comprises a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel.

Optionally, the color of the color resists of the first sub-pixel and the fourth sub-pixel is blue, the color of color resist of the second sub-pixel is red, the color of color resist of the third sub-pixel is green.

Optionally, the color of the color resists of the first sub-pixel and the fourth sub-pixel is red, the color of color resist of the second sub-pixel is green, the color of color resist of the third sub-pixel is blue.

Optionally, the color of the color resists of the first sub-pixel and the fourth sub-pixel is green, the color of color resist of the second sub-pixel is red, the color of color resist of the third sub-pixel is blue.

Each of the pixel units further comprises a fifth sub-pixel, the fifth sub-pixel being arranged at one side of the first sub-pixel that is distant from the second sub-pixel or one side of the fourth sub-pixel that is distant from the third sub-pixel; and the fifth sub-pixel has color resist having a color of blank.

The present invention further provides a pixel structure, which comprises a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel;

wherein the color of the color resists of the first sub-pixel and the fourth sub-pixel is blue, the color of color resist of the second sub-pixel is red, the color of color resist of the third sub-pixel is green; and

wherein each of the pixel units further comprises a fifth sub-pixel, the fifth sub-pixel being arranged at one side of the first sub-pixel that is distant from the second sub-pixel or one side of the fourth sub-pixel that is distant from the third sub-pixel; and the fifth sub-pixel has color resist having a color of blank.

The efficacy of the present invention is that the present invention provides a pixel structure and a liquid crystal display panel, wherein, based on the theory of color, each of pixel units is provided with a first sub-pixel, a second sub-pixel, a third sub-pixel, and a fourth sub-pixel that are arranged sequentially along a straight line, wherein the first sub-pixel and the fourth sub-pixel are respectively arranged at two sides of the second sub-pixel and the third sub-pixel; the second sub-pixel and the third sub-pixel have areas that are the same; the first sub-pixel and the fourth sub-pixel have color resists having identical color; the first sub-pixel and the fourth sub-pixel have areas that are each one half of the area of the second sub-pixel. By setting the color of the color resists of the first sub-pixel and the fourth sub-pixel as a color that is opposite to the color toward which color shift may happen, color correction can be achieved and color shifts at different viewing angle may be compensated to thus improve color shift at large viewing angles.

### BRIEF DESCRIPTION OF THE DRAWINGS

For better understanding of the features and technical contents of the present invention, reference will be made to the following detailed description of the present invention and the attached drawings. However, the drawings are provided only for reference and illustration and are not intended to limit the present invention.

In the drawings:

FIG. 1 is a schematic view illustrating a conventional pixel structure;

FIG. 2 is a schematic top plan view illustrating a first embodiment of a pixel structure according to the present invention;

FIG. 3 is a schematic view illustrating a second embodiment of the pixel structure according to the present invention;

FIG. 4 is a schematic view illustrating a third embodiment of the pixel structure according to the present invention; and

FIG. 5 is a schematic view illustrating a fourth embodiment of the pixel structure according to the present invention.

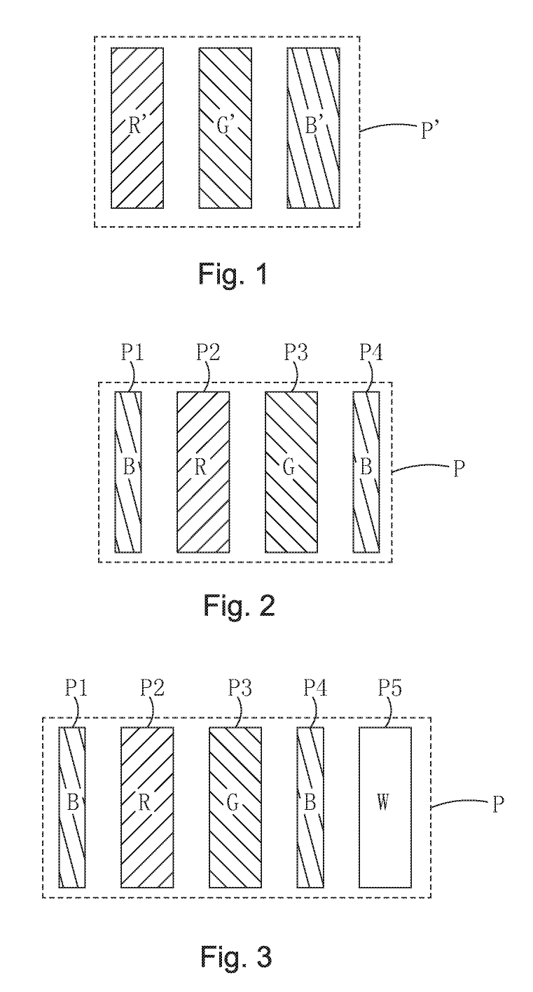

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

Firstly, the present invention provides a pixel structure. FIG. 2 shows a first embodiment of the pixel structure according to the present invention, comprising a plurality of pixel units P arranged in an array. Each of the pixel units P comprises a first sub-pixel P1, a second sub-pixel P2, a third sub-pixel P3, and a fourth sub-pixel P4 that are arranged sequentially alone a straight line. The first sub-pixel P1 and the fourth sub-pixel P4 are respectively arranged at two sides of the second sub-pixel P2 and the third sub-pixel P3; the first sub-pixel P1 and the fourth sub-pixel P4 have color resists that are of the same color, being both blue color B; the second sub-pixel P2 has a color resist that is of red color R, and the third sub-pixel P3 has a color resist that is of green color G; the second sub-pixel P2 and the third sub-pixel P3 have areas that are the same and the first sub-pixel P1 and the fourth sub-pixel P4 have areas that are each one half of the area of the second sub-pixel P2.

The first embodiment is provided in view of the most commonly seen condition that left and right viewing angles have the tendency of becoming yellowish. Since the opposite color of yellow is blue, based on the theory of color, setting the color of the color resists of the first sub-pixel P1 and the fourth sub-pixel P4 as blue color B may achieve color correction and thus compensating yellow color shifting at different viewing angles to thereby greatly improve yellow shifting at large viewing angles.

FIG. 3 shows a second embodiment of the pixel structure according to the present invention, which is different from the first embodiment in that each of the pixel units P additionally includes a fifth sub-pixel P5. Color resist of the fifth sub-pixel P5 has a color of blank W; the fifth sub-pixel P5 is arranged at one side of the first sub-pixel P1 that is distant from the second sub-pixel P2, or can be alternatively arranged at one side of the fourth sub-pixel P4 that is distant from the third sub-pixel P3, in order to increase light transmittance of the pixel.

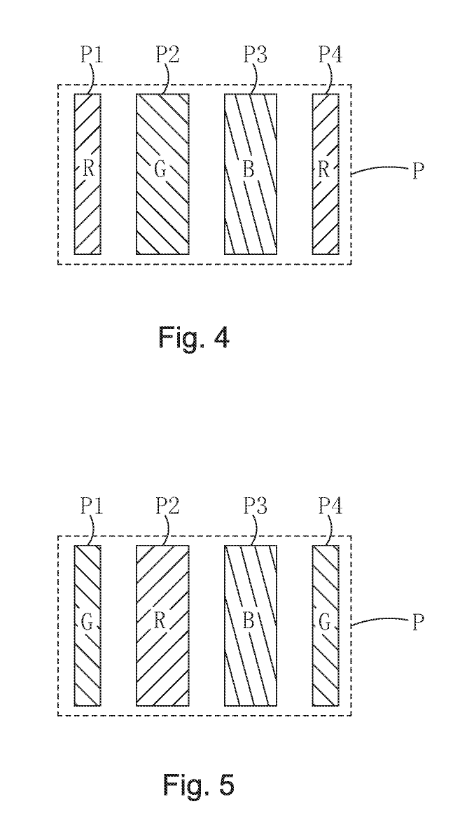

FIG. 4 shows a third embodiment of the pixel structure according to the present invention, comprising a plurality of pixel units P arranged in an array. Each of the pixel units P comprises a first sub-pixel P1, a second sub-pixel P2, a third sub-pixel P3, and a fourth sub-pixel P4 that are arranged sequentially alone a straight line. The first sub-pixel P1 and the fourth sub-pixel P4 are respectively arranged at two sides of the second sub-pixel P2 and the third sub-pixel P3; the first sub-pixel P1 and the fourth sub-pixel P4 have color resists that are of the same color, being both red color R; the second sub-pixel P2 has a color resist that is of green color G, and the third sub-pixel P3 has a color resist that is of blue color B; the second sub-pixel P2 and the third sub-pixel P3 have areas that are the same and the first sub-pixel P1 and the fourth sub-pixel P4 have areas that are one half of the area of the second sub-pixel P2.

The third embodiment is provided in view of the condition that left and right viewing angles may possibly have the tendency of becoming greenish. Since the opposite color of green is red, based on the theory of color, setting the color of the color resists of the first sub-pixel P1 and the fourth sub-pixel P4 as red color R may achieve color correction and thus compensating green color shifting at different viewing angles to thereby greatly improve green shifting at large viewing angles.

It is apparent that, on the basis of the third embodiment, a fifth sub-pixel (not shown) of which color resist has a color of blank may also be possibly be added to increase light transmittance of the pixel.

FIG. 5 shows a fourth embodiment of the pixel structure according to the present invention, comprising a plurality of pixel units P arranged in an array. Each of the pixel units P comprises a first sub-pixel P1, a second sub-pixel P2, a third sub-pixel P3, and a fourth sub-pixel P4 that are arranged sequentially alone a straight line. The first sub-pixel P1 and the fourth sub-pixel P4 are respectively arranged at two sides of the second sub-pixel P2 and the third sub-pixel P3; the first sub-pixel P1 and the fourth sub-pixel P4 have color resists that are of the same color, being both green color G; the second sub-pixel P2 has a color resist that is of red color R, and the third sub-pixel P3 has a color resist that is of blue color B; the second sub-pixel P2 and the third sub-pixel P3 have areas that are the same and the first sub-pixel P1 and the fourth sub-pixel P4 have areas that are one half of the area of the second sub-pixel P2.

The fourth embodiment is provided in view of the condition that left and right viewing angles may possibly have the tendency of becoming reddish. Since the opposite color of red is green, based on the theory of color, setting the color of the color resists of the first sub-pixel P1 and the fourth sub-pixel P4 as green color G may achieve color correction and thus compensating green color shifting at different viewing angles to thereby greatly improve red shifting at large viewing angles.

It is apparent that, on the basis of the third embodiment, a fifth sub-pixel (not shown) of which color resist has a color of blank may also be possibly be added to increase light transmittance of the pixel.

Based on the same inventive idea, the present invention also provides a liquid crystal display panel, which involves the above-described pixel structure, so as to reduce the situation of color shift at large viewing angles, making the quality of displaying better. Repeated description of the pixel structure will be omitted here.

In summary, the present invention provides a pixel structure and a liquid crystal display panel, wherein, based on the theory of color, each of pixel units is provided with a first sub-pixel, a second sub-pixel, a third sub-pixel, and a fourth sub-pixel that are arranged sequentially along a straight line, wherein the first sub-pixel and the fourth sub-pixel are respectively arranged at two sides of the second sub-pixel and the third sub-pixel; the second sub-pixel and the third sub-pixel have areas that are the same; the first sub-pixel and the fourth sub-pixel have color resists having identical color; the first sub-pixel and the fourth sub-pixel have areas that are each one half of the area of the second sub-pixel. By setting the color of the color resists of the first sub-pixel and the fourth sub-pixel as a color that is opposite to the color toward which color shift may happen, color correction can be achieved and color shifts at different viewing angle may be compensated to thus improve color shift at large viewing angles.

Based on the description given above, those having ordinary skills in the art may easily contemplate various changes and modifications of he technical solution and the technical ideas of the present invention. All these changes and modifications are considered belonging to the protection scope of the present invention as defined in the appended claims.

What is claimed is:

1. A pixel structure, comprising a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel.

2. The pixel structure as claimed in claim 1, wherein the color of the color resists of the first sub-pixel and the fourth sub-pixel is blue, the color of color resist of the second sub-pixel is red, the color of color resist of the third sub-pixel is green.

3. The pixel structure as claimed in claim 1, wherein the color of the color resists of the first sub-pixel and the fourth sub-pixel is red, the color of color resist of the second sub-pixel is green, the color of color resist of the third sub-pixel is blue.

4. The pixel structure as claimed in claim 1, wherein the color of the color resists of the first sub-pixel and the fourth sub-pixel is green, color of color resist of the second sub-pixel is red, the color of color resist of the third sub-pixel is blue.

5. The pixel structure as claimed in claim 1, wherein each of the pixel units further comprises a fifth sub-pixel, the fifth sub-pixel is arranged at one side of the first sub-pixel that is distant from the second sub-pixel or one side of the fourth sub-pixel that is distant from the third sub-pixel; and the fifth sub-pixel has color resist having a color of blank.

6. A liquid crystal display panel, comprising a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel.

7. The liquid crystal display panel as claimed in claim 6, wherein the color of the color resists of the first sub-pixel and the fourth sub-pixel is blue, the color of color resist of the second sub-pixel is red, the color of color resist of the third sub-pixel is green.

8. The liquid crystal display panel as claimed in claim 6, wherein the color of the color resists of the first sub-pixel and the fourth sub-pixel is red, the color of color resist of the second sub-pixel is green, the color of color resist of the third sub-pixel is blue.

9. The liquid crystal display panel as claimed in claim 6, wherein the color of the color resists of the first sub-pixel and the fourth sub-pixel is green, the color of color resist of the second sub-pixel is red, the color of color resist of the third sub-pixel is blue.

10. The liquid crystal display panel as claimed in claim 6, wherein each of the pixel units further comprises a fifth sub-pixel, the fifth sub-pixel being arranged at one side of the first sub-pixel that is distant from the second sub-pixel or one side of the fourth sub-pixel that is distant from the third sub-pixel; and the fifth sub-pixel has color resist having a color of blank.

11. A pixel structure, comprising a plurality of pixel units arranged in an array, each of the pixel units comprising at least a first sub-pixel, a second sub-pixel, a third sub-pixel, and a fourth sub-pixel arranged sequentially in a line, the first sub-pixel and the fourth sub-pixel being respectively arranged at two sides of the second sub-pixel and the third sub-pixel, the second sub-pixel and the third sub-pixel having areas that are identical, the first sub-pixel and the fourth sub-pixel having color resists having the same color, the first sub-pixel and the fourth sub-pixel having areas that are one half of the area of the second sub-pixel;
wherein the color of the color resists of the first sub-pixel and the fourth sub-pixel is blue, the color of color resist of the second sub-pixel is red, the color of color resist of the third sub-pixel is green; and
wherein each of the pixel units further comprises a fifth sub-pixel, the fifth sub-pixel being arranged at one side of the first sub-pixel that is distant from the second sub-pixel or one side of the fourth sub-pixel that is distant from the third sub-pixel; and the fifth sub-pixel has color resist having a color of blank.
